(19) United States
(12) Patent Application Publication
(10) Pub. No.: US 2026/0127424 A1
(43) Pub. Date: May 7, 2026

(54) PHOTONIC KOLMOGOROV-ARNOLD NETWORK

(71) Applicant: HEWLETT PACKARD ENTERPRISE DEVELOPMENT LP, Spring, TX (US)

(72) Inventors: SEAN HOOTEN, Milpitas, CA (US); YIWEI PENG, Spring, TX (US); YUAN YUAN, Milpitas, CA (US); STANLEY CHEUNG, Milpitas, CA (US)

(21) Appl. No.: 18/982,172

(22) Filed: Dec. 16, 2024

Related U.S. Application Data
(60) Provisional application No. 63/716,031, filed on Nov. 4, 2024.

(51) Int. Cl. G06N 3/067; G06N 3/048; G06N 3/06

(52) U.S. Cl. CPC G06N 3/067; G06N 3/048; G06N 3/061

(57) ABSTRACT

Systems and methods are provided for optically implemented Kolmogorov-Arnold Networks (KAN). Examples provide a photonic Kolmogorov-Arnold Network that includes a plurality of neurons and a plurality of synaptic edges. Each synaptic edge comprises a waveguide that optically couples a neuron of the plurality to another neuron of the plurality of neurons, and a nonlinear optical modulator formed on the waveguide, wherein the nonlinear optical modulator is configured to be tuned to a desired nonlinear activation function.

### CROSS REFERENCE TO RELATED APPLICATIONS

This application claims the benefit of and priority to U.S. Provisional Patent Application No. 63/716,031, filed on Nov. 4, 2024, the contents of which are incorporated herein by reference in their entirety.

### BACKGROUND

Driven by growing interest in artificial intelligence (AI), the global artificial neural network (ANN) market is projected to grow at a significant rate. ANNs and learning algorithms have the ability to learn from large data sets, which can create a machine having human-like decision making capabilities with low latency and high-energy efficiency. ANNs are computing systems inspired by biological neural networks, and consist of a collection of connected nodes or neurons that are connected by edges, which model synapses. Each neuron can receives signals from connected neurons, processes the received signals, and sends a signal to connected neurons. The output of each neuron is computed by a non-linear activation function of the sum of its inputs, called the activation function. The strength of the output at each connection can be determined by a weight, which adjusts during a learning process.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 depicts a schematic diagram of an optical device for an all-optical artificial neural network, in accordance with examples of the disclosed technology.

FIG. 2 illustrates example nonlinear activation functions that can be implemented along edges of the all-optical artificial neural network of FIG. 1.

FIG. 3 depicts a schematic diagram of a modulating unit cell, in accordance with implementations disclosed herein.

FIG. 4 depicts a schematic diagram of an example an optical modulator comprising a plurality of modulating unit cells of FIG. 3, in accordance with implementations disclosed herein.

FIG. 5 illustrates a graphical representation of accuracy and loss of an example all-optical artificial neural network according to one implementation disclosed herein.

FIGS. 6A and 6B illustrates a graphically comparison of performance an all-optical artificial neural network in accordance with the present disclosure against some conventional artificial neural networks.

FIG. 7 illustrates a schematic representation of pruning all-optical artificial neural network in accordance with an implementation of the present disclosure.

FIG. 8 is an example computing component that may be used to implement various features of photonic Kolmogorov-Arnold Networks in accordance with the implementations disclosed herein.

FIG. 9 is a computing component that may be used to implement examples of the disclosed technology.

The figures are not exhaustive and do not limit the present disclosure to the precise form disclosed.

### DETAILED DESCRIPTION

Examples of the technology disclosed herein provide for optically implemented Kolmogorov-Arnold Networks (KAN). Examples integrate an all-optical neuromorphic platform that leverages optical nonlinear activation functions (ONAFs) along synaptic edges interconnecting neurons of the KAN. The ONAFs can be implemented using optical modulators, such as, in some examples, cascaded ring-assisted Mach-Zehnder Interferometer (MZI) devices.

Some ANNs are implemented using Multi-Layer Perceptrons (MLPs). MLPs are fully-connected feedforward neural networks that consist of multiple layers of nodes. Each node can process information by applying a fixed activation function to a weighted sum of its inputs. MLPs can theoretically approximate any continuous function, given enough layers and nodes. This capability allows for widespread use in diverse deep learning tasks, such as classification, regression, and processing of natural language. While versatile, MLPs may also have limitations, including challenges in interpreting learned representations and difficulties in scaling the network effectively.

KANs present an alternative to traditional MLPs. One distinction between KANs and MLPs is in a KAN's ability to learn activation functions on the edges that interconnect nodes. As a result, edges of a KAN can implement weights using learned activation functions. In some cases, KANs can be trained to implement nonlinear activation functions (NAFs) on the edges, which can enable nonlinear weighting of outputs from connected nodes. This is in contrast to the weight-static approach offered by MLPs, thereby offering greater flexibility during training. Certain KAN models can utilize B-splines to construct activation functions, replacing linear weight parameters with adaptable spline-based functions. The advantages of this approach, such as, but not limited to, scalability, flexibility, efficiency, and interpretability, have spurred further investigation into the potential of KANs.

Generally, digital electronics hardware has been used to implement ANNs, such as MLPs and KANs. Nevertheless, traditional electronic computing platforms may encounter obstacles as transistor-based chips can struggle to satisfy increasing performance demands (e.g., data processing speeds and reduced latency) without consuming excessive power. Furthermore, electronic computing may be constrained by its clock speed, leading to restricted inference bandwidth and latency bottlenecks.

Integrated photonic accelerators performing analog processing have emerged as alternatives to the electronics hardware due to ultra-high speed, parallelism, energy efficiency, and real-time processing that can be enabled by processing in the photonic domain (also referred to herein as the optical domain). For example, optical systems, including Mach-Zehnder Interferometers (MZI) meshes, microring resonator (MRR) crossbars, and coherent MRR networks, have been used to implement MLP layers in the photonic domain. These accelerators primarily rely on weight-static neural networks to provide for the MLPs.

Despite the potential, current photonic accelerators for implementing MLPs may face challenges that limit their practical usefulness. For example, photonic accelerators may lack depth due to the absence of efficient on-chip nonlinear activation functions (NAFs). Current ANN architectures, relying on cascaded MLPs and NAFs, may be challenging to implement directly in the all-optical domain. For example, traditional optical neural networks (ONNs), which conventionally rely on optical-electrical-optical (OEO) conversions for nonlinear operations, may introduce increased latency, increased power consumption (e.g., 0.1 W per channel), and may consume on-chip real estate through a bulky footprint. These problems can be exacerbated in deep neural networks, where multiple OEO conversions can diminish the advantages of photonic accelerators.

As another example, photonic accelerators may also have limited network bandwidth, which can cause a struggle with extensibility due to design limitations. For instance, conventional MZI-based ONNs tend to rely on Singular Value Decomposition (SVD) techniques by combining meshes of cascaded 2×2 MZIs. In such implementations, an N×N matrix may require 2N nodes of 2×2 MZIs, where N is a number of elements, with a minimum of (N+1) MZIs and maximum of (2N+1) MZI. This configuration can result in accumulated loss as the number N increases, which necessitates higher laser power or additional amplifiers to compensate thereby increasing energy consumption.

Thus, ANN architectures pose challenges for scaling photonic accelerators, particularly when attempting to tackle problems that are more complex. As an illustrative example, while a single NVIDIA H100 GPU can handle a popular language model GPT-2 XL with 1.5 billion parameters, some current optical neural networks may be limited to a scale of 64×64 (e.g., 4096 parameters) or smaller.

The examples disclosed herein overcome these challenges by providing photonic accelerators implementing KANs. More particularly, photonic accelerators can be provided as optical devices configured to implement photonic KANs. In examples, the optical devices include a plurality of neurons (or nodes) connected by a plurality of synaptic edges. Each synaptic edge may be embodied as a waveguide that optically couples a neuron to another neuron. Nonlinear optical modulators can be formed on the waveguides, each of which can be tuned to a desired NAF. The nonlinear optical modulators, when tuned to a NAF, may be considered an ONAF.

In examples, the plurality of neurons can be organized into a plurality of layers. Neurons of a one layer may be connected to neurons of next layer (e.g., a subsequent or downstream layer) by synaptic edges, each of which can be implemented as a respective waveguide that optically couples a neuron of the one layer with a neuron of the next layer. NAFs can be provided on the synaptic edges as nonlinear optical modulators, which can be tuned to apply a nonlinear weighted connection between connected neurons. That is, for example, the weighting applied by a synaptic edge can be dependent upon the signal output by a neuron in a nonlinear way, thereby leading to greater flexibility. The nonlinearly activated signals on the synaptic edges can be summed at the neurons of the next layer, for example, by one or more optical combiners included as part of the neuron. The one or more optical combiners may combine the weight signals and output the weight signal onto a waveguide that optically connects the neuron of the next layer with a neuron of a successively next layer.

As an illustrative example, the plurality of layers may include an input layer, at least one hidden layer comprising, and an output layer. The input layer may comprise a first subset of neurons (sometimes referred to herein as input neurons) of the plurality of neurons. Each hidden layer may comprise a respective subset of neurons (sometimes referred to herein as hidden neurons) of the plurality of layers, for example, the at least one hidden layer may comprise a second subset of neurons of the plurality of layers. The output layer comprises a third subset of neurons (sometimes referred to herein as output neurons) of the plurality of neurons.

In this example, assume the input layer comprises two input neurons, each receiving an input optical signal. The input optical signal may be encoded with data according to known modulation techniques. A first input neuron may be configured to split a first input optical signal amongst a first set of waveguides (e.g., a first set of synaptic edges) that connect the first input neuron to hidden neurons of a first hidden layer. A second input neuron may split a second input optical signal amongst a second set of waveguides (e.g., a second set of synaptic edges) that connect the second input neuron to the hidden neurons of the first hidden layer. Each hidden neuron of the first hidden layer can be connected to both input neurons via respective waveguides. The hidden neurons of the first hidden layer may be configured to combine optical signals on the respective waveguides using one or more optical combiners, which supply the combined optical signals to downstream waveguides connecting the hidden neurons of the first hidden layer to neurons of the successively next layer (e.g., a second hidden layer or the output layer depending on the configuration).

Each waveguide embodying the synaptic edges may include a nonlinear optical modulator configured to apply a desired NAF. In illustrative examples, a nonlinear optical modulator may comprise a pair of optical components (also referred to as a set of components), which can be tuned to provide a desired NAF. A pair of optical components constituting a nonlinear optical modulator may comprise a directional coupler and an interferometer. For example, each nonlinear optical modulator may include at least one directional coupler (e.g., a Mach-Zehnder coupler (MZC) in some examples) that is optically coupled to at least one interferometer (e.g., a Mach-Zehnder Interferometer (MZI) in some examples). In the case of an MZI, the MZI may be implemented as a microring-assisted MZI (RAMZI) comprising a microring formed on one branch of the MZI and a phase-shift mechanism on the opposite branch. The directional coupler may include a phase-shift mechanism on one branch. The phase-shift mechanisms and resonance of the microring can be tuned to achieve the desired nonlinear activation function. In some examples, an optical amplifier may be provided between the optical components of a given pair of optical components, for example, at the output of the RAMZI in the above examples. The optical amplifier may also be tuned, in tandem with or independent of tuning the phase-shift mechanisms and resonance of the microring, to achieve the desired nonlinear activation function. In some examples, a plurality of pairs of optical components can be provided along a given waveguide, each of which can be individually or collectively tuned so to achieve a desired nonlinear activation function.

The technology disclosed herein can provide various non-limiting advantages over prior ONNs. For example, implementations disclosed herein can provide for improved scalability. The optically implemented KANs according to the present disclosure can provide for linear power scaling with network bandwidth, thereby overcoming growth limitations of other photonic accelerators and improving scalability.

Implementations disclosed herein can also provide for improved accuracy and convergence speed while training an ANN. For example, when provided the same number of parameters, the optically implemented KANs disclosed herein can outperform photonic MLPs by a factor 103 in mean-squared error for some function regression tasks. Alternatively, the optically implemented KAN achieves similar performance to the photonic MLP with reduced number of parameters (e.g., 16% of the parameters in some examples). This can lead to models having smaller footprints and lower computational demands as compared to photonic MLPs.

Implementations disclosed herein can also provide for improved efficiency in reaching a solution. For example, implementations disclosed herein can deliver increased energy efficiency with increased network depth, smaller footprints and reduced latency. Some implementations of the disclosed technology, as described below, can provide approximately 2× increase in energy efficiency with increased network depth and up to 75,000× or greater increase in energy efficiency with increased network width. Such energy efficiency can be achieved with 1.35× smaller footprint and 7× latency reductions compared to prior photonic accelerators with equivalent parameters.

Furthermore, implementations disclosed herein can provide improved interpretability. For example, the optically implemented KANs disclosed herein may be amenable to pruning, which can lead to enhanced interpretability. This can allow for easier identification and correction of errors or unexpected behaviors.

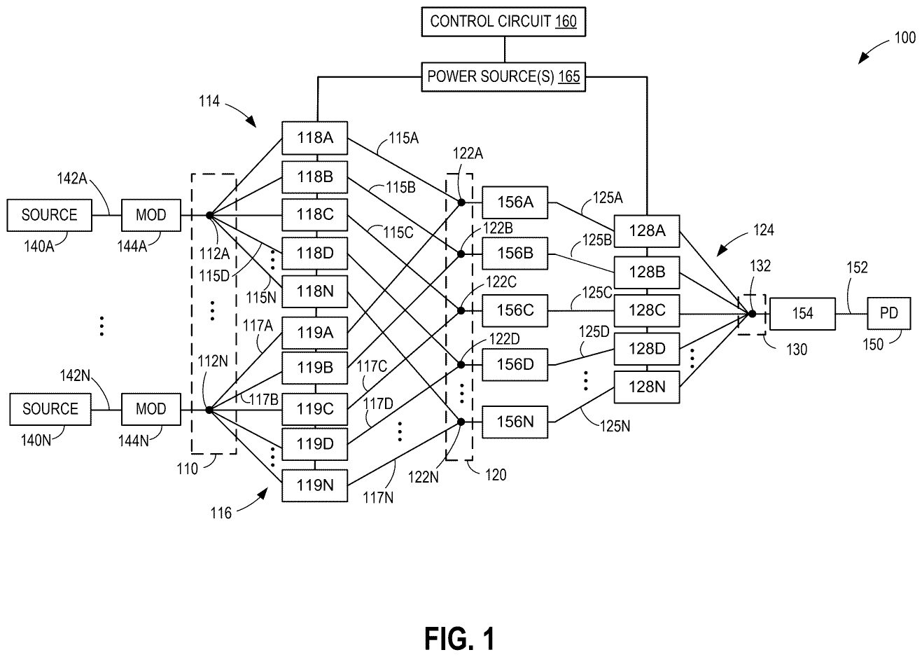

FIG. 1 depicts a schematic diagram of an optical device 100 for an all-optical artificial neural network, in accordance with examples of the disclosed technology. The optical device 100 includes an input layer 110, one or more hidden layers 120, and an output layer 130. The input layer 110 comprises a plurality of input neurons 112A-112N (collectively referred to herein as input neurons 112) and the output layer 130, in this example, comprises an output neuron 132. While a single output neuron 132 is shown in FIG. 1, examples herein may include any number of output neurons as desired for a given application. In the example of FIG. 1, the hidden layer(s) 120 comprises one hidden layer consisting of a plurality of hidden neurons 122A-122N (collectively referred to herein as hidden neurons 122). However, examples herein may include any number of hidden layers, each of which comprises a respective plurality of hidden neurons.

As shown in FIG. 1, each neuron is connected to neurons of a next layer by a synaptic edge. More particularly, each neuron of a given layer is connected to each of the neurons of the next layer via a set of synaptic edges. In the example of FIG. 1, the input neuron 112A is connected to each of the hidden neurons 122A-122N by a first set of synaptic edges 114, where the number of synaptic edges is equal to the number of hidden neurons 122A-122N. This configuration ensure that an output signal from the input neuron 112A can be distributed to each of the hidden neurons 122A-122N. Likewise, the input neuron 112N is connected to each of the hidden neurons 122A-122N by a second set of synaptic edges 116. If more than two input neurons where to be provided, they as well would be connected to each hidden neuron 122A-122N via a respective set of synaptic edges. Similarly, as shown in FIG. 1, each hidden neuron 122A-122N can be connected to the output neuron 132 by a set of synaptic edges 124. In the case of more than one output neuron, each hidden neuron 122A-122N would be connected to each respective output neuron via a respective set of synaptic edges.

In examples, the synaptic edges 114, 116 and 124 may be implemented as waveguides. For example, the synaptic edges 114 may be implemented as waveguides 115A-115N (collectively referred to herein as waveguides 115), the synaptic edges 116 may be implemented as waveguides 117A-117N (collectively referred to herein as waveguides 117), and the synaptic edges 126 may be implemented as waveguides 125A-125N (collectively referred to herein as waveguides 125). As an illustrative example, in a silicon (Si) photonic platform, synaptic edges 114, 116, and 124 may be implemented as Si waveguides, or other semiconductor material suitable for propagating optical signals.

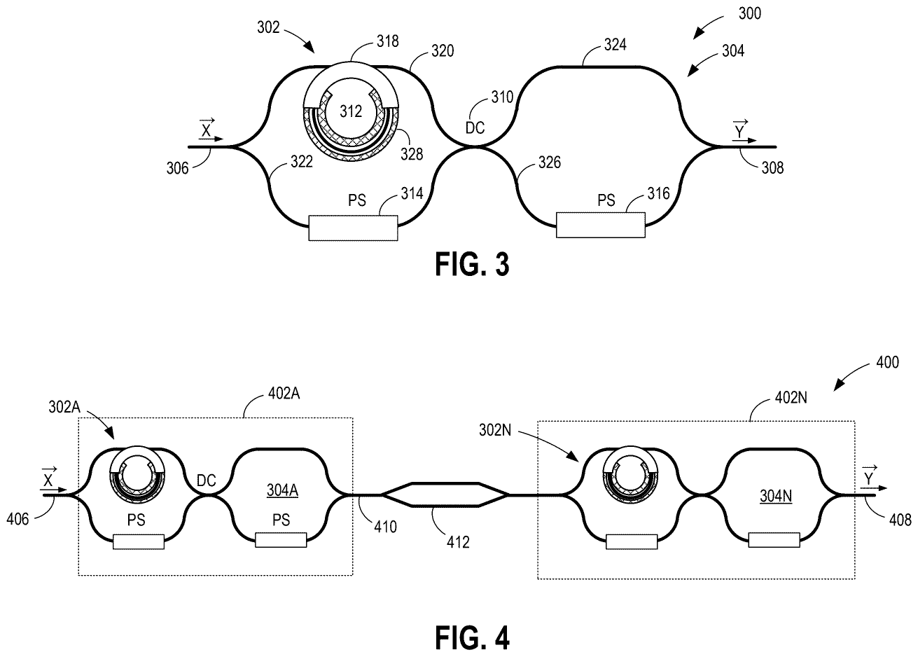

In examples, the synaptic edges 114, 116 and 124 may also comprise nonlinear optical modulators configured to provide a desired NAF. For example, as shown in the FIG. 1, the synaptic edges 114, 116 and 124 comprises nonlinear optical modulators 118A-118N (collectively referred to herein as nonlinear optical modulators 118), 119A-119N (collectively referred to herein as nonlinear optical modulators 119), and 128A-128N (collectively referred to herein as nonlinear optical modulators 128) formed on or otherwise integrated into the waveguides 115, 117, and 125, respectively. An example non-linear optical modulator is provided below in connection with FIGS. 3 and 4.

In examples, the nonlinear optical modulators 118, 119, and 128 can be tuned to apply a nonlinear weight to optical signals propagating in waveguides 115, 117, and 125, respectively. That is, for example, a respective nonlinear optical modulator can be tuned to apply a nonlinear activation function to an input optical signal traversing along a respective waveguide. The nonlinear activation function may comprise adaptable parameters that define a weight to be applied to the input optical signal as a function of the input optical signal. Thus, the weight can be dependent upon the optical signal input into the optical modulator and can be varied according to characteristics of the input optical signal, thereby leading to greater flexibility.

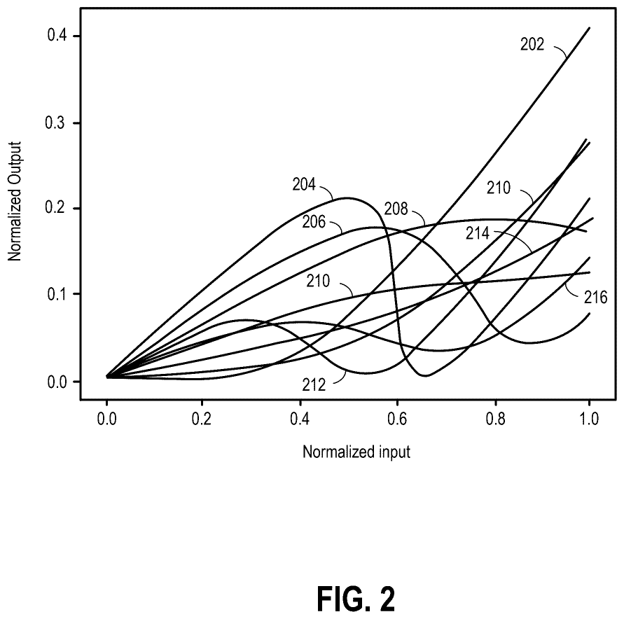

For example, FIG. 2 depicts a graph of various NAFs that may be applied to an input optical signal by an optical modulator according to an example implementation. FIG. 2 illustrates example NAFs 202-216 plotted as a normalized amplitude of the output optical signal as a function of normalized amplitude of the input optical signal. The NAFs 202-216 may be defined by a set of trainable parameters. Through training, a given nonlinear optical modulator can be tuned to apply a desired NAF from among the NAFs 202-216. When an optical signal is input into the nonlinear optical modulator tuned to apply a desired NAF, the output optical signal will have an amplitude weighted based on the amplitude of the input optical signal according to the tuned NAF. As can be seen from FIG. 2, the weighting applied to the output optical signal can be nonlinear in that the value (or magnitude of the weight) may vary with amplitude of the input optical signal.

While examples herein are described with reference to amplitude of the input optical signals, examples herein are not limited to this implementation. For example, nonlinearity may be exhibited based on a phase, polarization, wavelength, or any other characteristics of the input optical signal. As an illustrative example, the magnitude of the weight applied by the nonlinear optical modulator may be varied across different wavelengths of input optical signals, different polarizations, or difference phases.

Returning to FIG. 1, in this example, the input layer 110 comprises two input neurons 112A and 112N, each receiving an encoded input optical signal. The input optical signals may be generated by a respective optical source, such as optical sources 140A and 140N in this example. In an example implementation the optical sources can be implemented as lasers or other source capable of emitting an optical signal (e.g., light) into waveguides 142A and 142N. The optical signals emitted by optical sources 140A and 140N can be modulated by optical modulators 144A and 144N, respectively, to encode the optical signals with data according to known modulation techniques. The optical modulators can be optically coupled or otherwise integrated into waveguides 142A and 142N, respectively.

In examples, neurons may comprise one or more optical splitters and/or one or more optical combiners. For example, input neurons 112 may each consist of one or more optical splitters configured to split the encoded input optical signal into a plurality of signals that can be supplied to the waveguides 115 and 117. In some examples, each input neuron 112 may include a 1:N splitter, where is the number of neurons in the successively next layer (e.g., hidden layer 120 in this example), configured to split the encoded input signal equally into an N number of optical signals. In another example, each input neuron 112 may include a plurality of cascaded 1:2 splitters that collectively split the encoded input optical signal into an N number of optical signals. In either case, the input neurons 112A and 112N output a plurality of optical signals into waveguides 115 and 117, respectively.

As the output optical signals traverse respective waveguides 115 and 117, the respective nonlinear optical modulators 118 and 119 apply a desired NAF to the optical signal. As noted above, the nonlinear optical modulators 118 and 119 can be tuned to achieve the desired NAF that provides a nonlinear weighting to the output optical signal from the input neurons 112A and 112N. The nonlinear weighted optical signal are received by the hidden neurons 122 as weighted input optical signals. Each hidden neuron 122 may comprise one or more optical combiners configured to combine (e.g., sum) the weighted input optical signals received via from each input neuron 112A and 112N via respective waveguides 115 and 117. For example, hidden neuron 122A can be optically coupled to waveguide 115A and 117A and may comprise one or more optical combiners that function to combine the weight optical signals received from waveguides 115A and 117A.

The neurons 122 can be configured to supply the combined optical signals to respective waveguides 125 as inputs for the successively next layer (e.g., output layer 130 in this example. Similar to the above, the combined optical signals traverse respective waveguides 125, which apply a desired NAF based on tuning of optical modulators 128. The resulting nonlinear weighted optical signals are then supplied to the output neuron 132, which comprises one or more optical combiners that operate to combine the optical signals on waveguides 125 and output the combined signal onto an output waveguide 152. The resulting optical signal can be detected by a photodetector 150. The amplitude of optical signal output from the output neuron 132 may be used for provide a solution or result of the ONN. For example, the ONN may be trained for classification, in which case the amplitude of the optical signal at the output neuron 132 may be used for classifying the data encoded into the input optical signals by the modulators 144A and 144N. That is, the data encoded into the input optical signals may be classified according to a correspondence between the output from the output neuron 132 and attributes associated with a label.

The examples herein may include optical amplifiers (e.g., silicon optical amplifiers in the case of a Si photonic platform). For example, as shown in FIG. 1, optical amplifier 154 may be formed or otherwise integrated into output waveguide 152. Optical amplifier 154 may function to amplify for the combined optical signal from neuron 132 to improve detection by 150 (e.g., increase the amplitude above background noise). Similarly, optical amplifiers 156A-156N may be formed or otherwise integrated into waveguides 125, as shown in FIG. 1. As such, the amplitude of optical signal output by neurons 122 can be increased via optical amplifiers 156.

As described above, the optical device 100 can be used to implement a KAN. A KAN employs adaptable NAFs on the synaptic edges (also referred to as network edges). The learning of a complex, high-dimensional function can be simplified to the learning of a manageable number of one-dimensional functions. This approach can empower a KAN with a highly flexible and adaptable architecture, capable of dynamic adjustment to intricate data patterns. As a result, a KAN layer with nᵢₙ-dimensional inputs and nₒᵤₜ-dimensional outputs can be defined as a matrix of 1D functions:

$$Φ = \{ {ϕ}_{q , p} \} , p = 1 , … , {n}_{in} , q = 1 , … , {n}_{out} \qquad Eq . 1$$

where the functions φ_{q,p} are univariate functions (e.g., NAFs) having trainable parameters. In examples, each function can be defined as a spline, Chebyshev orthogonal polynomial, radial basis function, or the like (e.g., examples of which are illustrated in FIG. 2). The j^{th} NAF of i^{th} neuron in the l^{th} layer can be denoted as φ_{l,i,j}. The activation value of the (l+1, j) neuron can be simply the sum of all incoming activation functions:

$${x}_{l + 1 , j} = {\sum }_{i = 1}^{{n}_{l}} {ϕ}_{l , i , j} ( {x}_{l , i} ) \qquad Eq . 2$$

Each layer's transformation (φₗ) acts on the input xₗ to produce the next layer's input xₗ₊₁ in matrix form, which can be described as:

$${x}_{l + 1} = {ϕ}_{l} ( {x}_{l} ) = ( \begin{matrix}{ϕ}_{l , 1 , 1} ( \cdot ) & … & {ϕ}_{l , 1 , {n}_{l}} ( \cdot ) \\ ⋮ & ⋱ & ⋮ \\ {ϕ}_{l , {n}_{l + 1} , 1} ( \cdot ) & … & {ϕ}_{l , {n}_{l + 1} , {n}_{l}} ( \cdot )\end{matrix} ) \qquad Eq . 3$$

A general KAN network consists of L layers, and hence may be expressed as:

$$KAN ( x ) = ( {Φ}_{L - 1} ∘ {Φ}_{L - 2} ∘ … ∘ {Φ}_{0} ) ( x ) \qquad Eq . 4$$

As such, referring to FIG. 1, optical device 100 can be employed to provide a photonic neuromorphic architecture that leverages tunable NAFs along synaptic edges, according to the KAN discussed in connection with Eq. 1-4. As shown in FIG. 1, optical sources 140A and 140B emit input optical signals that undergoes modulation via modulators 144A and 144N. The encoded input optical signals then passes through one or more optical splitters of input neurons 112. If the power of the input optical signal is insufficient, additional optical sources can be cascaded with optical sources 140A and 140N to boost the power. Each optical modulator 118, 119, and 128 can be tuned to a NAF denoted as φ_{l,i,j}. For example, optical modulator 118A can be tuned to exhibit φ_{0,1,1}, optical modulator 118B can be tuned to @0,1,2, and so on. Similarly, optical modulator 119A can be tuned to exhibit φ_{0,2,1}, optical modulator 119B can be tuned to φ_{0,2,2}, and so on. Further, optical modulator 128A can be tuned to exhibit φ_{1,1,1}, optical modulator 128B can be tuned to φ_{1,1,2}, and so on. In examples, the desired function can be learned through training, for example, by tuning the nonlinear optical modulators based on training data, as described below in more detail.

Tuning of the nonlinear optical modulators may be achieved using a control circuit 160 that is electrically connected to one or more power sources 165. The one or more power sources 165 can be electrically connected to each nonlinear optical modulator 118, 119, and 128. In examples, voltage bias can be applied to the optical modulators by the one or more power sources 165 according to control by the control circuit 160. The one or more power sources 165 may act as signal sources that can lead to nonlinear optical losses and/or gain within the optical modulators 118, 119, and 128, thereby applying a nonlinear weighting to optical signals propagating therein. An example is provided below in connection with FIGS. 3 and 4.

FIG. 3 depicts a schematic diagram of a modulating unit cell 300 in accordance with implementations disclosed herein. The modulating unit cell 300 may be implemented as any one of nonlinear optical modulators 118, 119, and/or 128 of FIG. 1. In this example, modulating unit cell 300 comprises a pair of optical components. The pair of optical includes a Mach-Zehnder Interferometer (MZI) 302 optically coupled to a Mach-Zehnder Coupler (MZC) 304 via a directional coupler 310. The MZI 302 receives the input optical signal x via an input waveguide 306 and the MZC 304 outputs the output optical signal \vec{y} via an output waveguide 308. In examples, the input waveguide 306 may an example implementation of a synaptic edge that connects a neuron of one layer to a neuron of another layer (e.g., as described in connection with FIG. 1 above). In this case, the input waveguide 306 may receive an output optical signal as optical signal x from a connected upstream neuron and output waveguide 308 may supply an input optical signal to a connected downstream neuron as output optical signal \vec{y}.

The modulating unit cell 300 can be tunable to provide a nonlinear response in the output optical signal output optical signal \vec{y} that is dependent upon the input optical signal \vec{x}. In the example of FIG. 3, the MZI 302 can be controlled (e.g., via control circuit 160) to change the phase and amplitude of the transmitted output optical signal \vec{y}. For example, the MZI 302 may comprise a MRR 312 to provide a MRR assisted MZI (RAMZI), and the MRR 312 can be employed to change the phase and the amplitude. The MZI 302 can convert a nonlinear phase to a nonlinear response. The phase of MZI 302 can be adjusted by a phase-shift mechanism 314. The MZC 304 can function as a tunable directional coupler, which is controlled by a phase-shift mechanism 316 optically coupled to a branch of the MZC. The various phase-shift mechanisms can provide for the programmability of the nonlinear function shape through tuning of relative phase differences within the structure, which may be provided as any mechanism capable of inducing a phase shift in an optical signal propagating through the respective waveguide. For example, a resonance wavelength of the MRR 312 can be tuned/detuned via a phase-shift mechanism 318, which can tune/detune a coupling coefficient between the MRR 312 and a branch of the MZI 302. The tuning/detuning can switch (e.g., configure or reconfigure) between various activation functions, such as, but not limited to, sigmoid, radial-basis, ReLU (e.g., ReLU, inverse ReLU, and leaky ReLU), and quadratic functions for different task applications.

The MZI 302 comprises branch 320 and branch 322, each of which may be implemented as waveguides to guide propagation of an optical signal. The MZI 302 includes phase-shift mechanism 314 optically coupled to one of branch 322 or branch 320 and at least one MRR 312 optically coupled to the other of branch 320 or branch 322. In the example of FIG. 3, the MRR 312 is coupled to branch 320 and phase-shift mechanism 314 is coupled to branch 322. However, in some examples, the phase-shift mechanism 314 and MRR 312 may be optically coupled to the same (or common) branch of the MZI 310. In this case, the phase-shift mechanism 314 may need to be adjusted to a reversed phase, relative to a configuration in which the phase-shift mechanism 314 and the MRR 312 are on opposite branches, to achieve similar functionality. Additional MRRs may be included in the other branch, or multiple MRRs may be included on one branch, depending on the implementation. The MRR 312, in some implementations, may include phase-shift mechanism 318, as well as an optical loss tuner 328. In examples, the optical loss tuner 328 may be implemented as a PN junction integrated with the waveguide of the MRR 312 to provide a tunable conductive path across the waveguide. Tuning this conductive path can create carrier accumulation/depletion within the waveguide that can tune the optical loss within the MRR 312, which can also be utilized to manipulate the phase.

The MZC 304 comprises branch 324 and branch 326, each of which may be implemented as waveguides to guide propagation of light (e.g., an optical signal such as a lasing mode). The MZC 304 includes phase-shift mechanism 316 in one of branches 324 or 326. In the illustrative example shown in FIG. 3, the phase-shift mechanism 316 is provided along branch 326; however, the phase-shift mechanism 316 may be provided along either branch.

The phase-shift mechanisms 314, 316, and 318 are configured to alter a phase of an optical signal propagating in a waveguide coupled to the respective phase-shift mechanism. Phase-shift mechanism 314, 316, and 318 may be provided as any mechanism capable of inducing a phase shift in an optical signal propagating through a respective waveguide. For example, the phase-shift mechanisms 314, 316, and/or 318 may be implemented as heating/cooling elements (e.g., resistive heaters or the like) that can be operated to change a temperature of a coupled waveguide, thereby inducing a change in the effective refractive index and a resulting shift in phase. In an example, referring to FIG. 1, the control circuit 160 may cause one or more power sources 165 to apply a voltage bias that adjusts a heating/cooling element to change the temperature. The change in temperature incudes shift in the refractive index of a coupled waveguide. As another example, the phase-shift mechanisms 314, 316, and/or 318 may be implemented as Metal-oxide-semiconductor capacitors (MOSCAPs) integrated into the respective waveguides. In this case, a voltage bias can be applied (e.g., via control circuit 160 controlling the one or more power sources 165) across the MOSCAP that causes carrier accumulation/depletion resulting in a change in the refractive index and induces a phase shift within the respective waveguide. In any case, phase-shift mechanism 316 can be controlled to tune a relative phase difference between branch 326 and branch 324 of MZC 304 by inducing a phase shift in branch 326. Phase-shift mechanism 314 can be controlled to tune a relative phase difference between branch 322 and branch 320 of MZI 302 by inducing a phase shift in branch 322. Phase-shift mechanism 318 can be controlled to tune a resonance frequency of the MRR 312 by inducing a phase shift in a resonance cavity (e.g., waveguide) of the MRR 312.

By tuning relative phase differences within the modulating unit cell 300, the phase-shift mechanisms 314, 316, and/or 318 function as tunable elements that can efficiently adjust relative phase differences within the structures of the modulating unit cell 300. As noted above, this adjustment can enable the modulating unit cell 300 to be programmed to configure the modulating unit cell 300 to achieve various NAF. For example, tuning one or more of the phase-shift mechanisms 314, 316, and/or 318 provides for switching between different NAFs. Thus, controlled tuning of phase-shift mechanisms 314, 316, and/or 318 provides for configuring the modulating unit cell 300 into a desired NAF, which can be changed at a later time through tuning/detuning of phase-shift mechanisms 314, 316, and/or 318. The modulating unit cell 300 can achieve these functions with high accuracy because the tunable elements can be controlled by an automated control system, such as control circuit 160 of FIG. 1. Accordingly, by leveraging the modulating unit cell 300, the examples herein can be used to replace standard static/linear edge weights with synaptic edges having adaptable and learnable functions.

As alluded to above, the nonlinearity can be provided by the MRR 312 by tuning the resonance frequency of the MRR 312 to provide nonlinear phase shift. More particularly, nonlinearity may originate from the accumulation of carriers due to free-carrier dispersion (FCD) within the MRR 312. The FCD induces a nonlinear phase shift that the MZI 302 can convert into a nonlinear transmission response. The FCD effect and resulting shape of the nonlinear transmission response (e.g. NAFs 202-216 of FIG. 2) can be tuned via several independent parameters, such as the phase tuner 318 and loss tuner 328. In examples, the FCD effect can be enhanced by providing an MRR 312 having a relatively high quality factor (Q factor) relative to a Q factor of the MZU 302 when the MRR 312 is not present (e.g., a Q factor of 10⁵ relative to a Q factor of approximately one when the MRR 312 is not present). The dynamic behavior of the modulating unit cell 300 can be modeled using rate equations and coupled-mode theory. The dynamic equations can be simplified with signal amplitude (a) in the MRR 312 and a free carrier density (N_{c}) as:

$$\frac{d a}{dt} = - ( j Δ ω + {γ}_{L} ) a - j {η}_{f c} {N}_{c} a - j μ \sqrt{{P}_{i n}} \qquad Eq . 5$$

$$\frac{d {N}_{c}}{dt} + \frac{{N}_{c}}{{τ}_{f c}} = ξ {\vert a \vert}^{4} \qquad Eq . 6$$

where Δω represents a detuning between input optical signal frequency and resonance frequency of the MRR 312; γ_{L}, μ, Pᵢₙ and τ_{fc} represent linear loss coefficient, field coupling coefficient, input optical power, and free carrier lifetime, respectively; η_{fc} and ξ represent free carrier effect and two-photon absorption, respectively; and j represents an imaginary value. In the case where the waveguides are formed from silicon, the Kerr effect can be omitted from Eq. 5 and 6 because of its negligible impact compared to the free carrier effect. If a different material is used to provide the waveguides, the Kerr effect may need to be considered in the above equations.

When operating at low power on the input optical signal \vec{x}, the output of the MRR 312 (e.g., signal coupled into branch 320) can be minimal near its initial resonant frequency. However, as input power rises, the resonance frequency undergoes a blue shift, resulting in a brief decrease in output power followed by a rapid increase, as shown in the examples of FIG. 2. Accordingly, the NAF exhibited by the MRR 312 can be tailored by adjusting loss and detuning resonance. These parameters can be individually tuned via carrier injection and thermal effects induced through controlled tuning of the phase-shift mechanism 318 (as well as PN junction 328), for example, via control circuit 160.

In the example of FIG. 3, the MZI 310 can offer enhanced programmability that assists with the nonlinearity provided by the MRR 312 through further phase manipulation. For example, the phase of an optical signal on branch 322 of the MZI 302 can be adjusted via phase-shift mechanism 314, which achieves constructive or destructive interference at varying input powers when combined at the output of the MZI 302. Additionally, the phase of an optical signal propagating in the MZI 302 can likewise be adjusted to achieve additional constructive or destructive interference at varying input powers the output of the MZC 304. Tuning of these aspects, alone or in combination, can provide finer selectability from various NAFs.

In examples, the ability to represent arbitrary NAFs along synaptic edges can be important for effective training of a KAN. Digital implementations of a KAN relies on highly parametric NAFs in the form of spline functions, often with more than a hundred trainable parameters per NAF. Consequently, representing NAFs in analog KANs can be a challenge for effective implementation. For example, modulating unit cell 300 may be limited to four parameters: one parameter for adjusting a phase of the MRR 312, one parameter for adjusting loss of the MRR 312, one parameter for controlling the phase-shift mechanism 314, and one parameter for controlling the phase-shift mechanism 316. To expand the range of available NAFs and provide more precise control over the behavior of the KAN, a plurality of modulating unit cells 300 can be cascaded within a single nonlinear optical modulator.

For example, FIG. 4 depicts a schematic diagram of an example an optical modulator 400 comprising a plurality of modulating unit cells in accordance with implementations disclosed herein. The optical modulator 400 may be implemented as any one of nonlinear optical modulators 118, 119, and/or 128 of FIG. 1. In this example, optical modulator 400 comprises a plurality of unit cells 402A-402N (collectively referred to herein as unit cells 402), each of which may be implemented as an instance of modulating unit cell 300 of FIG. 3. Each unit cell 402 may comprise a substantively similar structure, in that each unit cell 402 may include an MZI and MZC (e.g., MZI 302 and MZC 304 of FIG. 3). As detailed above in connection with FIG. 3, the MZI may comprise MRR (e.g., MRR 312) and a phase-shift mechanism 314 (e.g., phase-shift mechanism 314) and the MZC may comprise phase-shift mechanism (e.g., phase-shift mechanism 316). As such, optical modulator 400 can provide for 4*N tunable parameters, where N is the number of unit cells 402. Tuning these parameters can be used to switch between various NAFS (e.g., examples of which are shown in FIG. 2). That is, for example, tuning the parameters can change the shape of the transmission curve of the output optical signal.

In the example of FIG. 4, two unit cells 402 are shown providing a dual-RAMZI (D-RAMZI) configuration; however, any number of unit cells 402 may be utilized as desired. In this example, unit cell 402A comprises a MZI 302A and a MZC 304A (e.g., a first instance of modulating unit cell 300) and unit cell 402N comprises a MZI 302N and a MZC 304N (e.g., an N^{th} instance of modulating unit cell 300). In this case, MZI 302A of unit cell 402A receives the input optical signal x via an input waveguide 404 (e.g., an example of input waveguide 306), while the MZC 304N outputs the output optical signal \vec{y} via an output waveguide 408 (e.g., an example of output waveguide 308). Each unit cell 402 is coupled to another unit cell via an intermediate waveguide, one of which is shown as intermediate waveguide 410.

Optionally, the optical modulator 400 may include one or more optical amplifiers (e.g., silicon optical amplifiers in the case of a Si photonic platform), illustratively depicted in FIG. 4 as optical amplifier 412. The one or more optical amplifiers may be provided between adjacent unit cells to amplify the optical signals on the intermediate waveguides 410. Each optical amplifier may can be provided between adjacent unit cells 402 units to ensure sufficient optical power is suppled to a downstream unit cell for triggering nonlinearity. That is, for example, in the case of the D-RAMZI configuration of FIG. 4, the optical amplifier 412 may amplify the optical signal on intermediate waveguide 410 output from unit cell 402A to ensure nonlinearity is triggered in unit cell 402N. In examples, the amplification provided by the optical amplifiers may be tuned, in tandem with or independent of tuning the phase-shift mechanisms and resonance of the MRR of each unit cell 402, to achieve the desired NAF.

Accordingly, in examples referring to FIGS. 1, 3, and 4, a photonic KAN accelerator can be implemented as optical device 100 having modulating unit cell 300 and/or optical modulator 400 employed as the nonlinear optical modulators 118, 119, and 128 acting as synaptic edges between neurons. By directly connecting neurons through a nonlinear optical modulator, the examples herein may be able to minimize the distance traveled by optical signals for data processing. This can provide for improvements in power efficiency and latency, enabling communication that is both fast and energy-efficient. For example, an N×M KAN can be provided as NM nonlinear optical modulators. Where the nonlinear optical modulators are implemented as D-RAMZIs, 9×NM+M parameters are available for tuning MRR phase, amplitude, MZI phase, and amplifiers. Correspondingly, the learnable parameters of one MLP layer and one MZI-ONN layer are N² and 2N², respectively. Fortunately, KANs usually require much smaller network width and depth than MLPs.

Ideal performance of the examples disclosed herein can be benchmarked in simulation to characterize its expressivity given the limitations of the analog NAFs. The simulations employed PyTorch to implement the photonic KAN architecture depicted in FIG. 1. The simulations employed D-RAMZIs (e.g., shown in FIG. 4) as nonlinear optical modulators, with parameters that are learned using a semi-analytical approach. For example, nonlinearity was precomputed using Equations 5 and 6, with input power swept from 0 to 0.2 mW in 100 steps. To enable differentiation, this nonlinearity was interpolated by sweeping the loss and the phase in 16 steps, respectively. For the remaining D-RAMZI elements, an analytical approach was adapted based on S-matrices, with the phase shift mechanism continuously tunable across a 0 to 2π range.

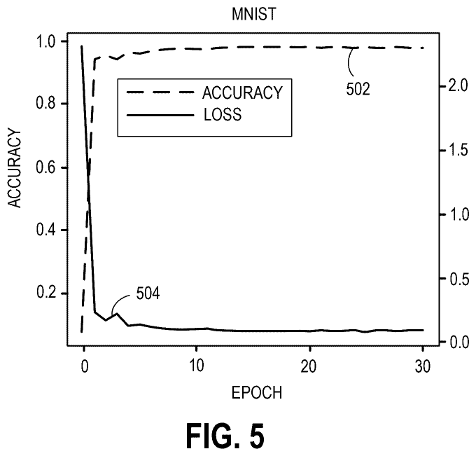

The simulations utilized the two-layer photonic KAN network, shown in FIG. 1, trained on the MNIST datasets. Categorical Cross-Entropy loss was utilized, along with the AdamW optimizer with a learning rate of 1×10-2 and an exponential learning rate scheduler (gamma 0.95) over 30 epochs. FIG. 5 illustrates a graphical representation of accuracy (line 502) and loss (line 504) as a function of training epoch. As shown in FIG. 5, the photonic KAN network achieved a competitive 98% accuracy on MNIST, which is comparable to conventional electronically implemented KANs. The photonic KAN network demonstrates rapid convergence, achieving over 80% accuracy after a single training epoch as shown in FIG. 5. These results highlight the potential of photonic KANs for image classification tasks, with further improvement through additional training epochs and optimization.

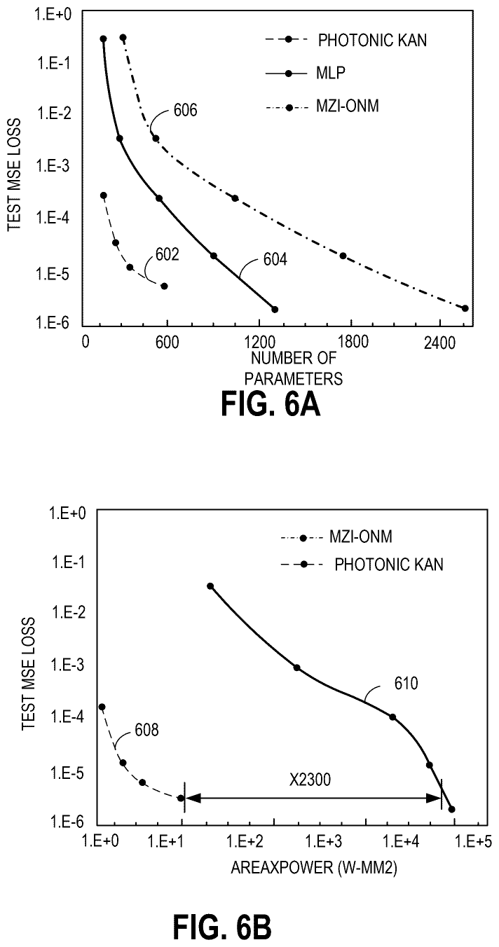

MLPs can perform poorly on high-frequency components, which may be crucial for multiscale partial differential equations (PDEs), image and audio compression, and medical applications. FIG. 6A compares the performance of the photonic KANs disclosed herein ideal MLPs and conventional photonic MZI-based ONNs on function-fitting tasks involving high-frequency components. Performance, shown as Test Mean Squared Error (MSE) Loss as a function of number of parameter, of the photonic KAN is shown as line 602, ideal MLP is shown as line 604, and conventional photonic MZI-based ONNs is shown as line 606. For this simulation, a function

$$y = sin ( \frac{π}{2} x ) + 0.1 sin ( 10 π x )$$

was fitted using the two layer photonic KAN of FIG. 1 and an MLP. As shown in FIG. 6, the KAN complexity (e.g., number of parameters) was increased from [1,3,3,1] to [1,5,5,5,1] and MLP complexity was increased [1,10,10,1] to [1,20,20,20,20,1], while maintaining the same dataset and optimizer (e.g., AdamW). As the results show, the photonic KAN demonstrates faster convergence and higher accuracy with the same number of parameters. The unitary properties of the MZI architectures complicate building MLPs, thereby requiring MZI-based ONNs to use twice the tunable parameters to match MLP performance.

FIG. 6B compares performance as a function of power consumption and area (e.g., footprint) for the two layer photonic KAN against that of a photonic MZI-based ONN (e.g., the Clement's MZI ONN). FIG. 6B shows the performance of the photonic KAN as line 608 and the MZI-based ONN as the line 610. As can be seen from FIG. 6B, the photonic KAN can improve the footprint-energy efficiency by around 2300× while achieving a similar accuracy. This may be due to one or more of the following reasons: reduced parameter requirements for the task; fewer MZIs, decreasing area and power consumption; and shorter optical path lengths that exponentially lower the required input optical power.

In practice, a priori knowledge of the underlying data distribution may be lacking, which can make it difficult to predefine a network structure. Approaches to determine this shape automatically would be desirable. To provide for such, examples herein may start from an overparameterized photonic KAN and leverage sparsity regularization during training followed by pruning. This approach can produce photonic KANs having improved interpretability compared to those without pruning. This approach may also decrease hardware energy consumption.

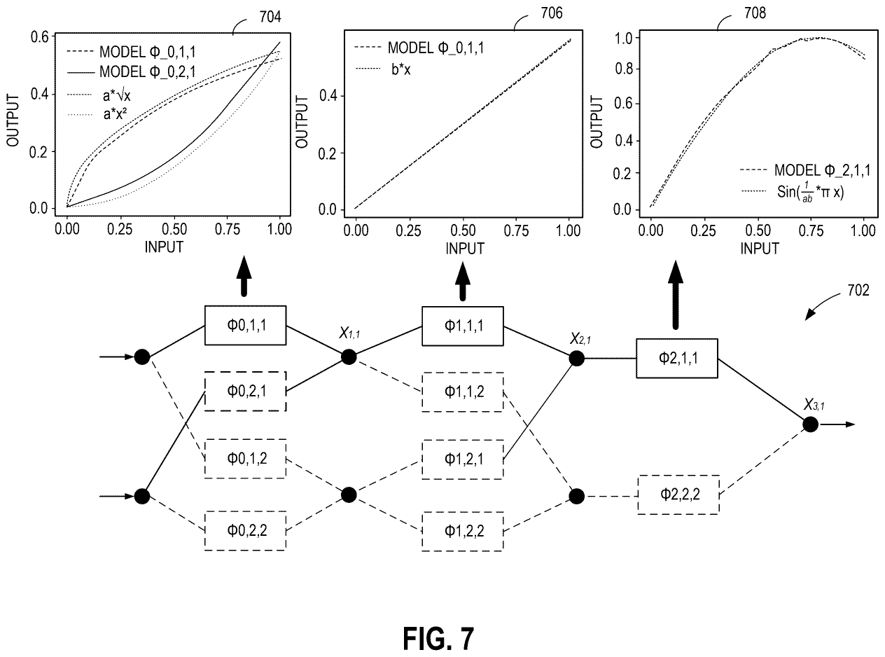

As an illustrative example, consider a function fitting task that fits a function ƒ(x, y)=sin (π(\sqrt{x}=y²). FIG. 7 illustrates a schematic representation of a 3-layer photonic KAN, according to the examples disclosed herein, utilized to execute the function fitting task. FIG. 7 depicts a schematic visualization of a pruned network 702 with outputs at each layer shown as graphical representations 704-708. In this example, an ideal KAN may be able to express the function perfectly. Examples herein train an overparameterized Photonic KAN with sparsification regularization, including L1 regularization and entropy regularization, as known in the art. The regularization strategy is augmented by incorporating an additional coefficient, A(φ₁), that specifically targets certain parameters, like the amplifier gain and/or phase shifts within the edges. This aims to drive these parameters towards zero, promoting sparsity and simplifying the model. Examples herein may begin with a fully-connected [2, 2, 2, 1] KAN, uniformly sample a number of points (e.g., 100 points in this example) at the input layer (e.g., x_{0,1} and x_{0,2}), and apply sparsification regularization during training to encourage the network to learn a sparse representation. Subsequent pruning, based on score thresholds, can remove ‘useless’ nodes with weak incoming or outgoing connections (shown as dashed nodes). Visualizing the pruned network shown in FIG. 7 reveals that functions with low magnitudes can be effectively faded out, highlighting the important functional components. As such, automatic pruning can successfully simplify the photonic KAN to a [2, 1, 1, 1] structure in place of the fully-connected [2, 2, 2, 1]. As shown in outputs 702-704, NAFs of the remaining edges can visually resemble known symbolic functions (e.g., \sqrt{x}, x², and sin(x)), making it possible to interpret the mathematical relationships captured by the model. In the hardware itself, ‘useless’ nodes can be deactivated by physically disconnecting them, which effectively sets their corresponding amplifier gains to zero.

As alluded to above, examples disclosed herein provide for improved latency, power, footprint, and energy efficiency compared to conventional electrical ONNs and electrically implemented KANs. For example, power consumption during static operation comes from six key sources: optical source power consumption, power consumed by driving optical amplifiers and mesh of nonlinear optical modulators, driving other modulators (e.g., modulators 144A and 144N), control circuitry, and photodetectors. As described above, optical amplifiers can compensate for losses, thereby alleviating power burden of the optical source and triggering nonlinearity in nonlinear optical modulators. While on-chip optical amplifiers can be a primary source of power consumption, their operation in the low-gain and linear region can minimize power drive requirements. Power consumed by nonlinear optical modulators can include contributions from MZI tuning, MRR tuning, and carrier injection.

Photon KANs according to the examples disclosed herein can be compared against the conventional Clements's MZI-based ONN and coherent MZI-Xbar ONN. On a silicon platform, the photonic KAN can reduce power consumption by 35% compared to Clements's ONN and by 50% compared to the coherent MZI-Xbar as network depth increases. These savings may be due to fewer MZI devices and reduced loss along the optical path. Additionally, power consumption of MZI-based ONNs was computed using all-optical nonlinearity and optical amplifiers, which showed higher power consumption than OEO conversion, as the NAF triggering power is higher than the PD sensitivity. This confirmed that the photonic KAN's efficiency stems from its architecture, opposed to the all-optical approach. Additionally, thanks to a shorter optical path, the photonic KANs disclosed herein can be well-suited to MOSCAP platforms, which provides zero static power consumption of MZI and MRR despite high loss. By adopting the MOSCAP platform, the photonic KAN of the present disclosure may need only half the power required by the Clements's MZI-based ONN and one-third of the coherent MZI-Xbar power.

The architectural differences between the photonic KANs disclosed herein, coherent MZI-Xbar ONNs, and conventional MZI-based ONNs can result in distinct scaling behaviors. For example, conventional N×N MZI-based ONNs require (2N+1) MZIs, leading to exponential increases in path loss and power consumption as network width grows. In contrast, the photonic KANs disclosed herein can use a fixed optical path through one nonlinear optical modulator per network edge, ensuring linear power scaling. Coherent MZI-Xbar ONNs, on the other hand, suffer more from additional losses due to couplers and crossings that grow with network width. As such, the photonic KANs disclosed herein can consume 15× less power than coherent MZI-Xbar ONNs and 75,000× less than Clements's MZI-based ONNs. Additionally, the photonic KANs disclosed herein can achieve similar accuracy with shallower network depth compared to MZI-based ONNs.

In terms of footprint, the photonic KANs disclosed herein can offer a distinct advantage over MZI-based ONNs. This may be due to the higher parameter density of nonlinear optical modulators along network edges. Each nonlinear optical modulator, while occupying a similar footprint to a conventional MZI unit, can contain twice the number of tunable parameters (e.g., four versus two). Accordingly, the photonic KANs disclosed herein can match the parameter count while reducing on chip real estate 35% by 50% space compared to Clements's MZI-based ONNs and MZI-Xbar ONNs, respectively. Moreover, the photonic KANs disclosed herein can achieve similar accuracy with as few as 16% of the parameters, resulting in a smaller network requirement. Additionally, the photonic KANs disclosed herein are pruning-friendly, allowing further footprint reduction without compromising accuracy.

Reducing latency in ONNs can be crucial for unlocking their full potential in real-world applications. The optics latency increases approximately linearly with the size as the optical path increases. Latency due to OEO conversion remains almost the same for each layer. The photonic KANs disclosed herein can achieve a 7× reduction in overall latency by eliminating the need for multiple OEO conversions and enabling short optical path.

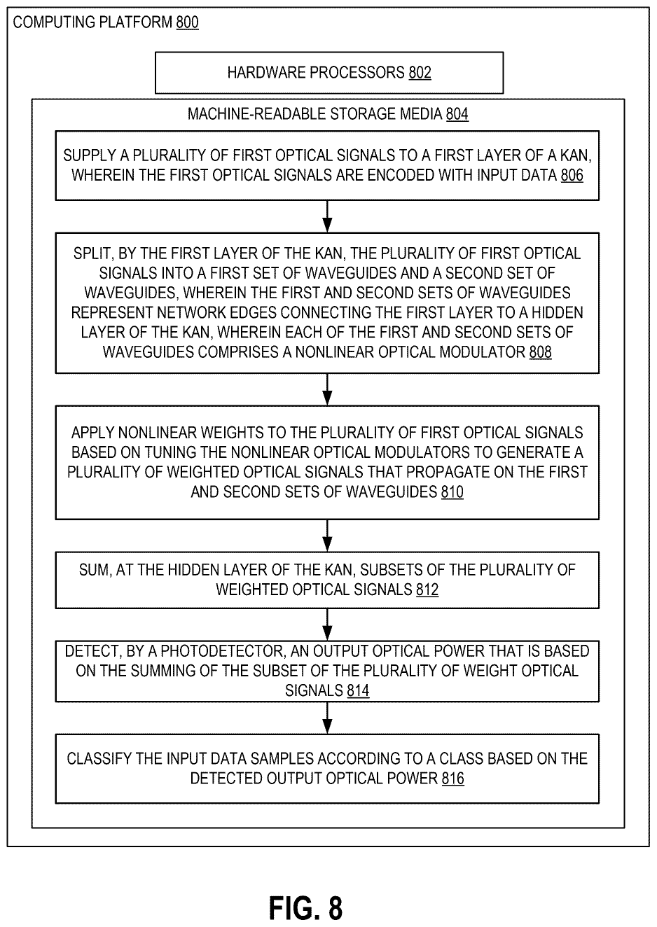

FIG. 8 illustrates a computing component that may be used to implement photonic KANs in accordance with various examples of the disclosed technology. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium for 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-816, to control processes or operations disclosed herein. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-816.

Hardware processor 802 may execute instruction 806 to supply a plurality of first optical signals to a first layer of a KAN. The first optical signals are encoded with input data. For example, as described above in connection with FIG. 1, optical sources may emit an input optical signal that can be modulated via modulators (e.g., modulators 144A and 144N) to encode data onto the input optical signals to provide the first optical signals.

Hardware processor 802 may execute instruction 808 to split, by the first layer of the KAN, the plurality of first optical signals into a first set of waveguides and a second set of waveguides. The first and second sets of waveguides can represent network edges (also referred to as synaptic edges) connecting the first layer to a hidden layer of the KAN. Each of the first and second sets of waveguides comprises a nonlinear optical modulator. FIG. 1 illustrates an example in which the input layer includes input neurons connected to hidden neurons of a hidden layer via a first and second set of waveguides. Each waveguide comprises a nonlinear optical modulator formed thereon, for example, according to the modulating unit cell 300 of FIG. 3 or the optical modulator 400 of FIG. 4.

Hardware processor 802 may execute instruction 810 to apply nonlinear weights to the plurality of first optical signals based on tuning the nonlinear optical modulators to generate a plurality of weighted optical signals that propagate on the first and second sets of waveguides. For example, as described above in connection with FIGS. 3 and 4, each nonlinear optical modulator can include at least one MZI having an MRR and a phase-shift mechanism, at least one MZC having a phase-shift mechanism, and, optionally, an optical amplifier therebetween. The MRR may also include a phase-shift mechanism and a PN junction. Parameters of the various phase-shift mechanism, the optical amplifier, and the PN junction can be used to tune the nonlinear optical modulator to change a transmission curve and select a desired nonlinear activation function (e.g., as shown in FIG. 2). The nonlinear activation function provides a nonlinear response that applies a weight having a magnitude that is dependent on the optical power of the optical signal input into the nonlinear optical modulator.

As described above in connection with FIGS. 5 and 6, the parameters can be learned through training. For example, training data can be input into a fully connected photonic KAN (or in simulation) and used to learn parameters through supervised learning (e.g., adjusting parameters to optimize a difference between labeled training data and the output result). Furthermore, the fully connected photonic KAN can be pruned to provide an optimal structure that utilizes only those nodes and edges needed according to training. Unnecessary nodes can be deactivated.

Hardware processor 802 may execute instruction 812 to sum, at the hidden layer of the KAN, subsets of the plurality of weighted optical signals. For example, nodes of the hidden layer may include optical combiners connected to ones of the first and second set of waveguides, as described in connection with FIG. 1. The optical combiners function to sum the weighted optical signals.

Hardware processor 802 may execute instruction 814 to detect, by a photodetector, an output optical power that is based on the summing of the subset of the plurality of weight optical signals. For example, the photodetector can be optically coupled to an output layer, which is downstream of the hidden layer, as described above in connection with FIG. 1. The output layer can supply an output optical signal to the photodetector that is dependent on the sum of the weighted optical signals. In some examples, multiple hidden layers may be present, each having nonlinear activation functions on network edges connecting the layers. Each hidden layer may execute a summing and output a summed signal to a next layer, until the output layer is reached.

Hardware processor 802 may execute instruction 816 to classify the input data samples according to a class based on the detected output optical power. For example, the KAN may be trained for classification, in which case the power (e.g., amplitude) of the optical signal detected at the photodetector may be used for classifying the data encoded into the first optical signals according to a class. That is, the data encoded into the input optical signals may be classified into a class according to a correspondence between the output signal and attributes associated with a class. The data encoded into the first optical signals may then be labeled according to the determined class.

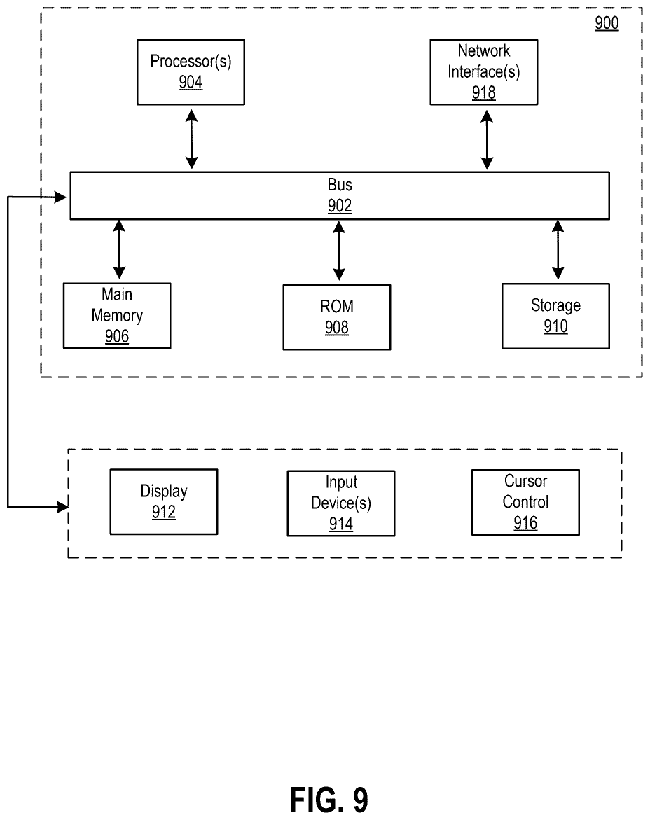

FIG. 9 depicts a block diagram of an example computer system 900 in which various examples of the disclosed technology described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors. The computer system 9000 may be implemented as one or more component of the optical device 100 described in connection with FIG. 1. For example, computer system 9000 may be implemented as control circuit 160.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions. For example, main memory 906 may store instructions, that when executed by processor(s) 904, cause computer system 900 to perform one or more of the operations described in connection with FIG. 8.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some examples, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one example of the disclosed technology, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a network interface 918 (also referred to as a communication interface) coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 918, which carry the digital data to and from computer system 900, are example forms of transmission media.

The computer system 900 can send messages and receive data, including program code, through the network(s), network link and network interface 918. In the Internet example, a server might transmit a requested code for an application program through the Internet, the ISP, the local network and the network interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A photonic artificial neural network comprising:
a plurality of neurons;
a plurality of synaptic edges, wherein each synaptic edge comprises:
a waveguide that optically couples a neuron of the plurality of neurons to another neuron of the plurality of neurons; and
a nonlinear optical modulator formed on the waveguide, wherein the nonlinear optical modulator is configured to be tuned to a desired nonlinear activation function.

2. The photonic artificial neural network of claim 1, the plurality of neurons are organized into a plurality of layers, wherein the plurality of layers comprises an input layer comprising a first subset of neurons of the plurality of neurons and a hidden layer comprising a second subset of neurons of the plurality of layers.

3. The photonic artificial neural network of claim 2, wherein the first subset of neurons comprises one or more optical splitters configured to split one or more input optical signals amongst a first set of waveguides corresponding to a first subset of synaptic edges of the plurality of synaptic edges, wherein the first set of waveguides optically couple the first subset of neurons to the second subset of neurons.

4. The photonic artificial neural network of claim 3, wherein the second subset of neurons comprises one or more optical combiners configured to combine optical signals propagating on the first set of waveguides, wherein the combined optical signals are based on the tuning of the nonlinear optical modulators.

5. The photonic artificial neural network of claim 3, wherein the first subset of neurons comprises a first neuron and a second neuron, and wherein the second subset of neurons are connected to the first neuron by a first subset of waveguides of the first set of waveguides and are connected to the second neuron by a second subset of waveguides of the first set of waveguides, wherein each of the second subset of neurons comprises one or more optical combiners configured to combine optical signals propagating on the first subset of waveguides with optical signals propagating on the second subset of waveguides.

6. The photonic artificial neural network of claim 3, wherein the optical signals propagating on the first and second subsets of waveguides are based on the tuning of the nonlinear optical modulators formed on each respective waveguide.

7. The photonic artificial neural network of claim 1, wherein the optical modulator comprises a directional coupler and an interferometer.

8. The photonic artificial neural network of claim 7, wherein the directional coupler comprises a first phase-shift mechanism.

9. The photonic artificial neural network of claim 7, wherein the interferometer is a ring assisted interferometer comprising a microring optically coupled to a first branch of the interferometer and a second phase-shift mechanism coupled to a second branch of the interferometer.

10. The photonic artificial neural network of claim 1, wherein the optical modulator comprises a first Mach-Zehnder coupler connected to a first ring-assisted Mach-Zehnder interferometer, a second Mach-Zehnder coupler connected to a second ring-assisted Mach-Zehnder interferometer, and an optical amplifier provided between the first ring-assisted Mach-Zehnder interferometer and the second Mach-Zehnder coupler.

11. The photonic artificial neural network of claim 1, wherein the photonic artificial neural network comprises a Kolmogorov-Arnold Network.

12. An optical device, comprising:
a plurality of sources to emit a plurality of input optical signals;
a plurality of optical splitters to split the plurality of input optical signal into a plurality of first optical signals;
a plurality of waveguides optically coupled to the plurality of optical splitters, wherein the plurality of waveguides receive the plurality of first optical signals from the plurality of optical splitters;
a plurality of optical combiners optically coupled to the plurality of waveguides; and
a plurality of nonlinear optical modulators formed on the plurality of waveguides between the plurality of optical splitters and the plurality of optical combiners, wherein the plurality of nonlinear optical modulators are tunable to select nonlinear activation functions from a plurality of nonlinear activation functions, wherein the plurality of nonlinear optical modulators apply the selected nonlinear activation functions to the plurality of first optical signals to generate a plurality of second optical signals,
wherein each of the plurality of optical combiners receives a subset of the plurality of second optical signals.

13. The optical device of claim 12, wherein the plurality of optical splitters represent neurons of a photonic artificial neural network.

14. The optical device of claim 13, wherein the plurality of waveguides represent network edges of the photonic artificial neural network.

15. The optical device of claim 13, wherein the photonic artificial neural network is a Kolmogorov-Arnold Network.

16. The optical device of claim 12, wherein the plurality of waveguides comprises:
a first subset of waveguides optically coupled to a first optical splitter of the plurality of optical splitters; and
a second subset of waveguides optically coupled to a second optical splitter of the plurality of optical splitters,
wherein each of the plurality of optical combiners is optically coupled to a waveguide of the first subset of waveguides and a waveguide of the second subset of waveguides.

17. The optical device of claim 12, wherein each of the nonlinear optical modulators comprises:
at least one microring-assisted Mach-Zehnder interferometer; and
at least one Mach-Zehnder coupler connected to the microring-assisted Mach-Zehnder interferometer.

18. The optical device of claim 12, wherein each of the nonlinear optical modulators comprises a dual microring-assisted Mach-Zehnder interferometer.

19. A method, comprising:
supplying a plurality of first optical signals to a first layer of a Kolmogorov-Arnold Network (KAN), wherein the first optical signals are encoded with input data;
splitting, by the first layer of the KAN, the plurality of first optical signals into a first set of waveguides and a second set of waveguides, wherein the first and second sets of waveguides represent network edges connecting the first layer to a hidden layer of the KAN, wherein each of the first and second sets of waveguides comprises a nonlinear optical modulator;
applying nonlinear weights to the plurality of first optical signals based on tuning the nonlinear optical modulators to generate a plurality of weighted optical signals that propagate on the first and second sets of waveguides;
summing, at the hidden layer of the KAN, subsets of the plurality of weighted optical signals; and
detecting, by a photodetector, an output optical power that is based on the summing of the subset of the plurality of weight optical signals; and
classifying the input data samples according to a class based on the detected output optical power.

20. The method of claim 19, wherein each of the nonlinear optical modulators comprises:
at least one Mach-Zehnder interferometer comprising a microring and a first phase-shift mechanism; and
at least one Mach-Zehnder coupler connected to the Mach-Zehnder interferometer and comprising a second phase-shift mechanism, and
wherein tuning the nonlinear optical modulators comprises adjusting one or more of: a phase of the microring, optical loss of the microring, a phase in the Mach-Zehnder interferometer based on the first phase-shift mechanism, and a phase in the Mach-Zehnder coupler based on the second phase-shift mechanism.
